(19) United States
(12) Patent Application Publication
(10) Pub. No.: US 2024/0383110 A1
(43) Pub. Date: Nov. 21, 2024

(54) SYNCHRONOUS FASTENER DRIVE TOOL

(71) Applicant: ZT Group Int'l, Inc., Sec, NJ (US)

(72) Inventors: Chen An, Secaucus, NJ (US); Mahesh Kumar Varrey, Secaucus, NJ (US); Lupeng Fan, Secaucus, NJ (US)

(21) Appl. No.: 18/668,990

(22) Filed: May 20, 2024

Related U.S. Application Data
(60) Provisional application No. 63/467,871, filed on May 19, 2023.
(60) Provisional application No. 63/468,904, filed on May 25, 2023.

(51) Int. Cl. B25B 17/00; B25B 21/00

(52) U.S. Cl. CPC B25B 17/00; B25B 21/002

(57) ABSTRACT

Drive tools having with gear trains that may be used to drive a plurality of fasteners simultaneously. The gear train may include a driving gear that drives a plurality of fastener driver gears, each of which is connected to a fastener driver. Each of the plurality of fastener drivers may be turned simultaneously by rotation of the driving gear, which may be used to turn a similar plurality of fasteners a desired number of turns so that a desired preload is achieved simultaneously.

### CROSS-REFERENCE TO RELATED CASES

This application claims priority to U.S. Provisional Patent Application No. 63/467,871, entitled “Synchronous Drive Tool For 4X Cold Plate Screws,” filed May 19, 2023, and to U.S. Provisional Patent Application No. 63/468,904, entitled “Synchronous Drive Tool For 4X Cold Plate Screws,” filed May 25, 2023, each of which is hereby incorporated by reference.

### BACKGROUND

Many mechanical assemblies are secured using screws that require the user the to tighten each screw to a specific preload. A preferred method for achieving a specific preload on a screw is by measuring of the elongation of the fastener, e.g., a screw or bolt, in comparison to its theoretical elongation at that preload.

FIG. 1 is an upper front isometric view illustrating a cold plate 20a connected to a CPU 30a within a server of the prior art. In FIG. 1, CPU 30a is connected to a base board 12 of the server (e.g., server 10, shown in FIG. 4 without a chassis). Cold plate 20a is fastened to CPU 30 using screws 22a . . . 22d, which are shown as having torx heads, but which may also be configured to accept other tool shapes, such as hex, Phillips, or flat heads, etc., or which may be another type of fastener, such as a bolt. Screws 22a . . . 22d compress springs 24a . . . 24d against screw plates 28a, 28b of cold plate 20a. Thus, cold plate 20a is pressed against CPU 30a by the force of compressed springs 24a . . . 24d. A top surface 26 of cold plate 20a is accessible from above when an upper section of the server chassis is removed to uncover baseboard 20a. A CPU 30b is configured similarly to 30a and illustrates the confined quarters in which cold plate 20a is placed.

Such installations may also have tedious procedures. An instruction manual for installing cold plate 20a atop CPU 30a calls for tightening screws 22a . . . 22d in a crisscross pattern in increments of 720°, i.e., two rotations at a time for each screw. This is time consuming and requires that the user be mindful to count the rotations while also following a crisscross pattern. A small error could cause one side of the cold plate to be tightened more than the others, which would result in exerting a force that could damage the chip.

Thus, there is a need for an apparatus that automates the procedure for installing fasteners.

### BRIEF DESCRIPTION OF THE DRAWINGS

The embodiments are illustrated by way of example and not limitation in the accompanying drawings, in which like references in multiple drawings indicate like elements, and in which:

FIG. 1 is an upper front isometric view illustrating a cold plate and CPU of the prior art;

FIG. 2 is a lower front right isometric view of an embodiment of a synchronous fastener drive tool;

FIG. 3 is an upper front left isometric view of an embodiment of a synchronous fastener drive tool in a use case;

FIG. 4 is an upper front left isometric view of an embodiment of a synchronous fastener drive tool in a use case;

FIG. 5 is an upper front left isometric view of an embodiment of a synchronous fastener drive tool in a use case;

FIG. 6A is an assembly drawing of an embodiment of a synchronous fastener drive tool;

FIG. 6B is a lower isometric view of an aspect of a synchronous fastener drive tool;

FIG. 7A is an upper front left isometric view of an embodiment of a synchronous fastener drive tool in a use case;

FIG. 7B is an isometric view of an enlarged section of FIG. 7A;

FIG. 7C is a cross-sectional view of the section indicated in FIG. 7A;

FIG. 8A is an upper front left isometric view of aspects of an embodiment of a synchronous fastener drive tool;

FIG. 8B is an enlarged view of the section indicated in FIG. 8A;

FIG. 8C is an upper front isometric view of aspects of an embodiment of a synchronous fastener drive tool;

FIG. 9A is a partially transparent view of an embodiment of a synchronous fastener drive tool in a first state;

FIG. 9B is a partially transparent view of an embodiment of a synchronous fastener drive tool in a second state;

FIG. 10A is an upper front left isometric view of an embodiment of a synchronous fastener drive tool;

FIG. 10B is an assembly drawing of an embodiment of a synchronous fastener drive tool;

FIG. 11A is an upper front left isometric view of aspects of an embodiment of a synchronous fastener drive tool;

FIG. 11B is an enlarged view of the section indicated in FIG. 11A;

FIG. 11C is an isometric view of an aspect of an embodiment of a synchronous fastener drive tool; and

FIG. 12 is an exemplary block diagram depicting a computing device of an embodiment.

### DETAILED DESCRIPTION

In embodiments, a drive tool with a gear train may be used to drive a plurality of fasteners, e.g., screws or bolts, at the same time. The gear train may have one central gear that drives two large gears, each of which further branches out with drive gears and idler gears that terminate in driving a drive socket that is fitted with a fastener driver. For example, four fasteners may be connected at the same time. But other embodiments with fewer, e.g., two or three, or more, e.g., five, or six, fastener drivers are envisioned.

In embodiments, the gear train may include gears, e.g., idler gears and drive gears, in a configuration that results in each drive socket rotating the same direction. The drive sockets may rotate in the same direction as the input to the drive tool. The input to the drive tool may be provided by a hand tool inserted into an initial drive socket and driven by a user rotating the hand tool. Or, the input to the gear train may be provided by a computer-controlled motor and drive bit.

In an embodiment, the rotation of each drive socket is hard-coupled to the input, which results in each drive socket rotating the exact same number of times for each rotation of the input drive socket. In this embodiment, the torque on each fastener may or may not be controlled.

In an embodiment, a user may manually disengage each driven gear in the gear train. This provides the ability to disengage a drive socket connected to a non-rotating fastener to allow the other drive sockets to continue rotating and installing their respective fasteners. In other words, the embodiment allows a user to manually disengage the socket driving a jammed fastener, or to disengage all sockets once they are fully tight to keep the gears from jamming and, e.g., make it difficult to remove the drive tool. In an embodiment, the ability to disengage a drive socket is provided by an idler gear that may be moved axially and disengaged from the fastener driver gear. In that embodiment, the axial movement may be caused by the user pulling an axial shaft of the idler gear. The embodiment may further include a latch that holds the shaft in a retracted position and maintains the disengagement of the idler gear from the fastener driver gear. The latch may include a V-shaped flexure component that is releasably received within a notch on the axial shaft to prevent the idler gear from re-engaging with the fastener driver gear. The presence of the notch may be a visual indicator that the idler gear is fully disengaged. In this embodiment, the idler gear may be moved axially to disengage from the fastener driver gear such that torque may not be transmitted from the driving gear to the fastener driver gear, and moved in the other axial direction to re-engage, i.e., mesh, with the fastener driver gear such that torque may be transmitted from the driving gear to the fastener driver gear by the gear train.

In an embodiment, torque limiters between the fastener driver gears and the fastener drivers may be incorporated to limit the torque of each fastener driver to predetermined value. In this manner, the embodiment may ensure that each fastener is torqued to the same value.

In an embodiment, a programmable controller may be used to control the rotation of an electric drive motor (e.g., direction, speed, and number of turns) that turns the fastener drivers through a gear train. Software controlling the controller may thus automate the installation or extraction of the fasteners, e.g., by limiting the number of turns of the electric motor to a predetermined value.

Embodiments may use latches with guiding features that releasably attach the drive tool securely to the device containing the fasteners. By constraining the movement of the drive tool with respect to the fasteners, damage to the devices being joined may be reduced, e.g., by maintaining a uniform pressure against the device being fastened during the process.

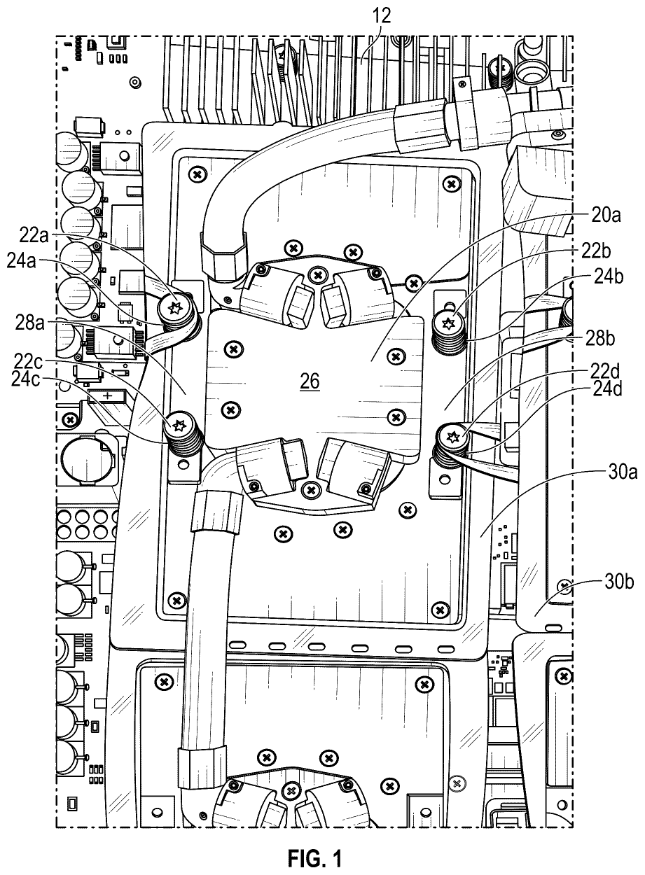

Embodiments may be applied to the use case of FIG. 1 in which screws are used to affix a cold plate to a CPU. In this use case, to achieve a proper preload, each of four screws are required to travel 2.17±0.6 mm. The instruction manual for this use case called for tightening the screws in a crisscross pattern in increments of 720°, which is two rotations each time for each fastener. However, with application of the embodiment, this time consuming and cumbersome task may be efficiently accomplished by driving all four screws the required total number of turns simultaneously, thus achieving the target preload on each screw at the same time.

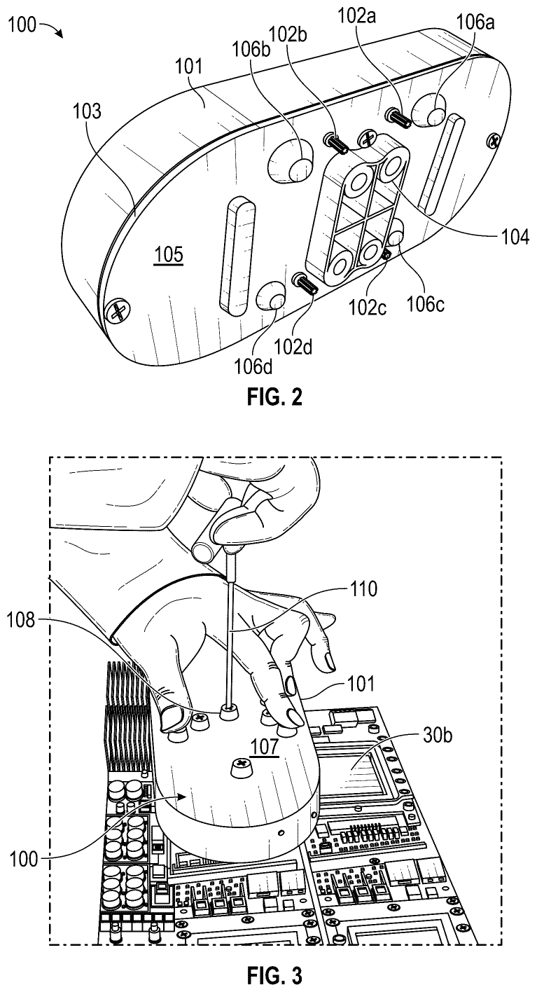

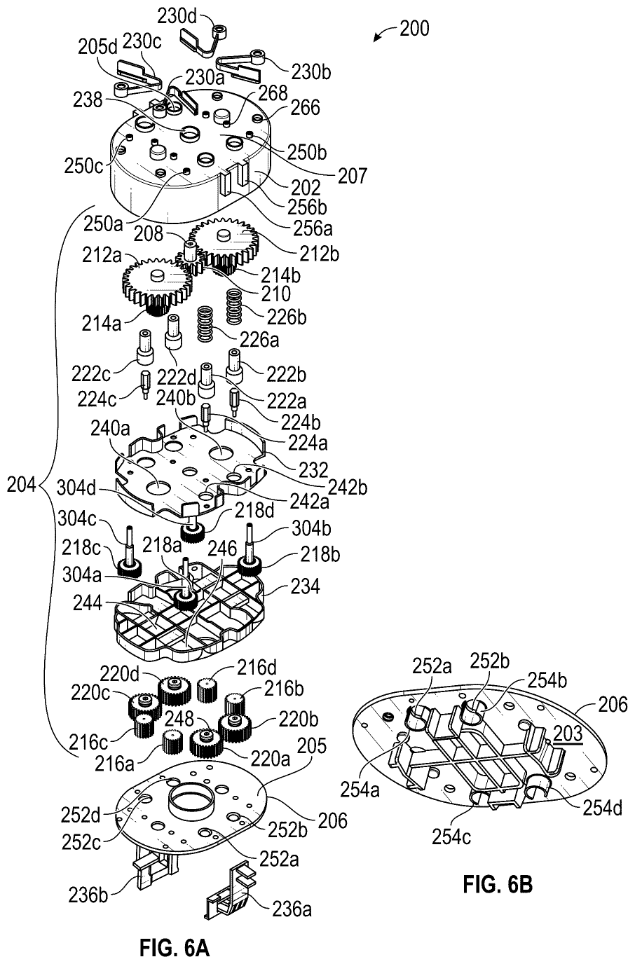

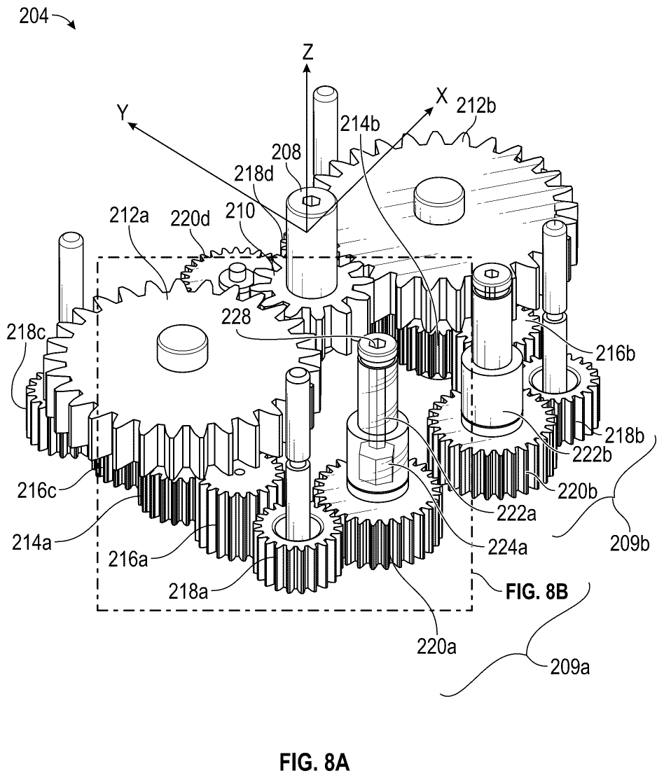

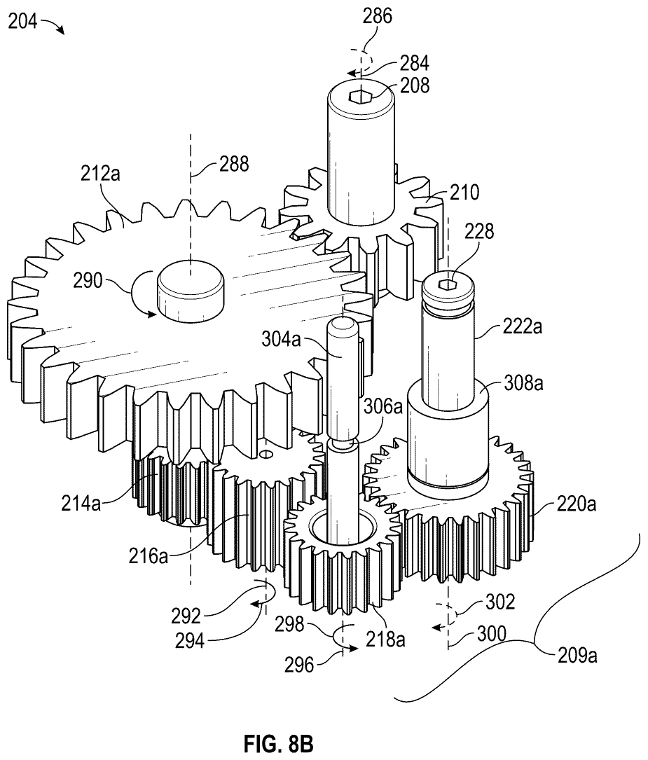

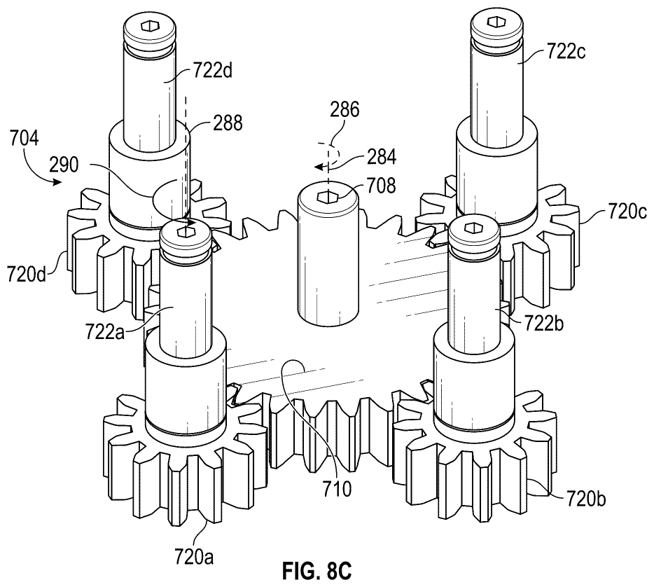

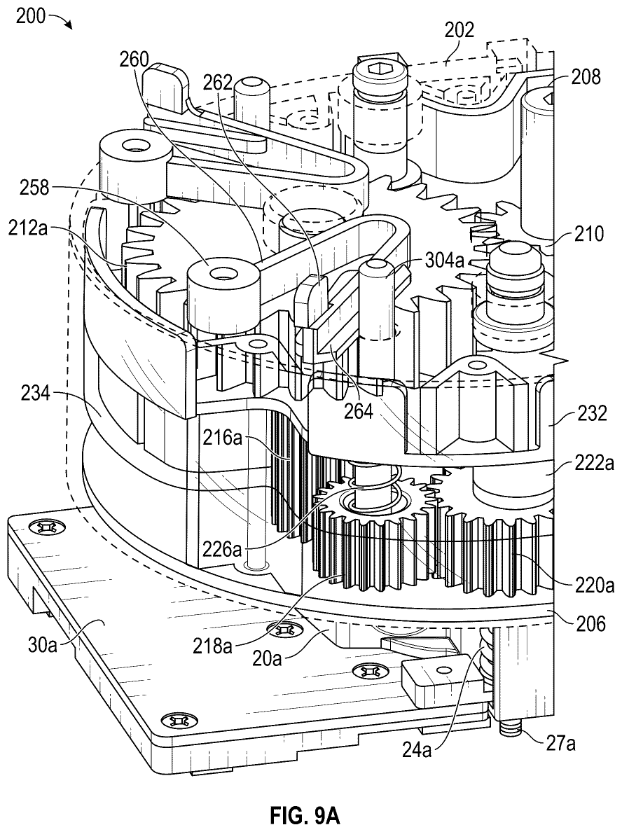

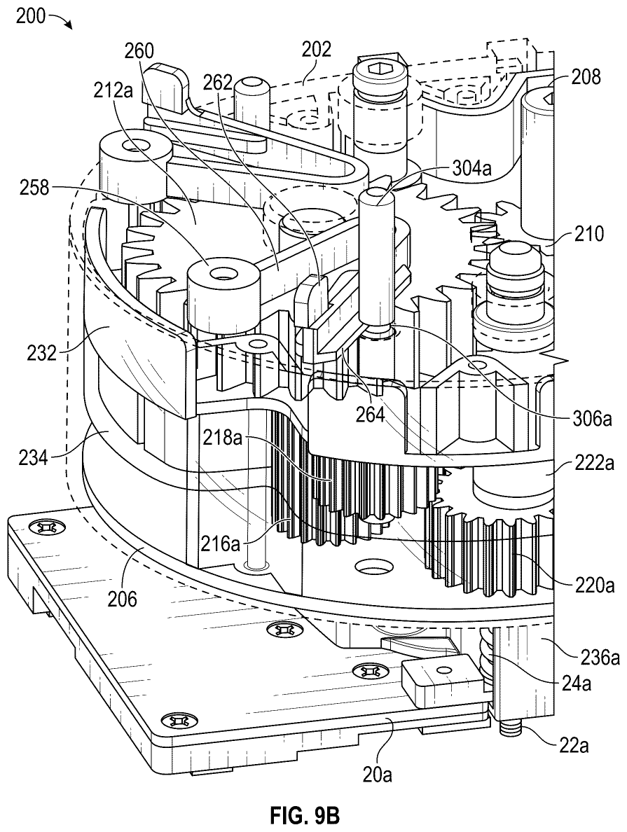

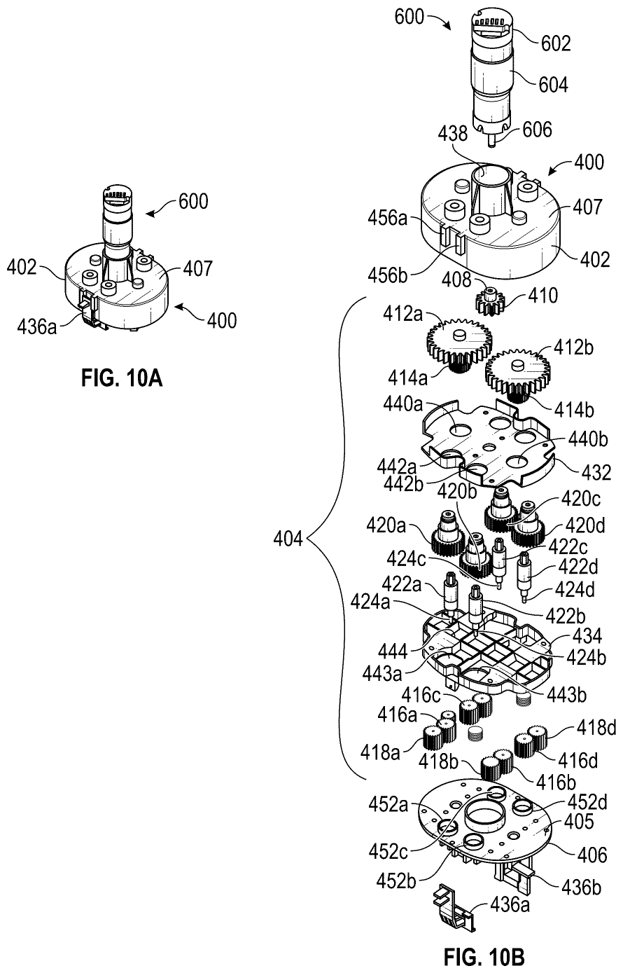

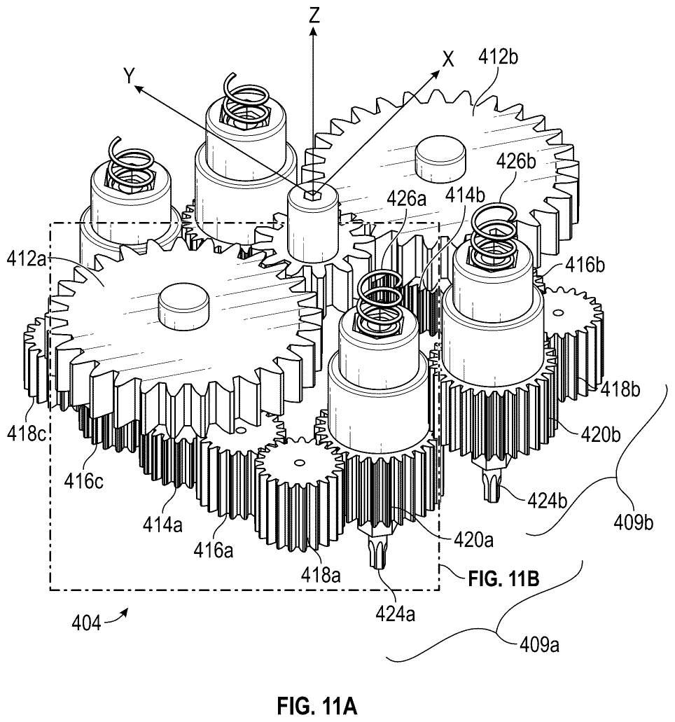

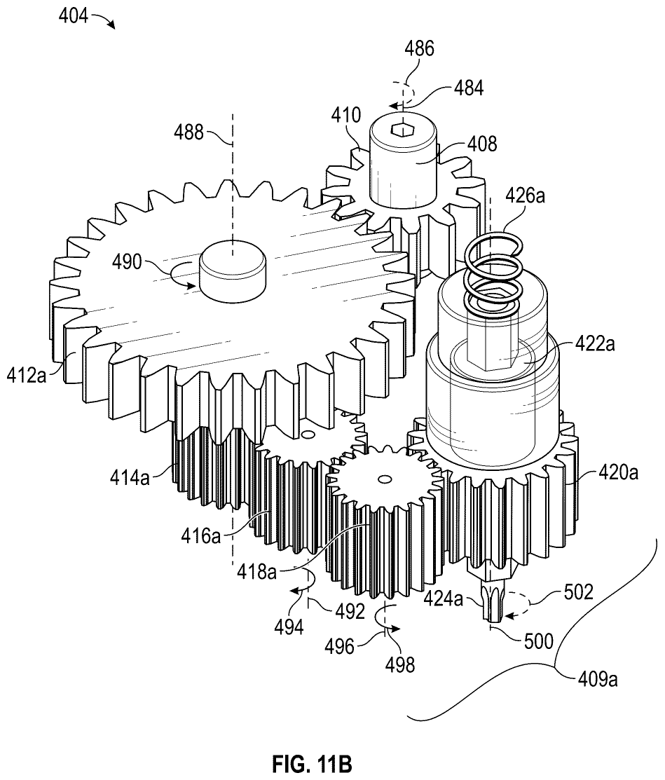

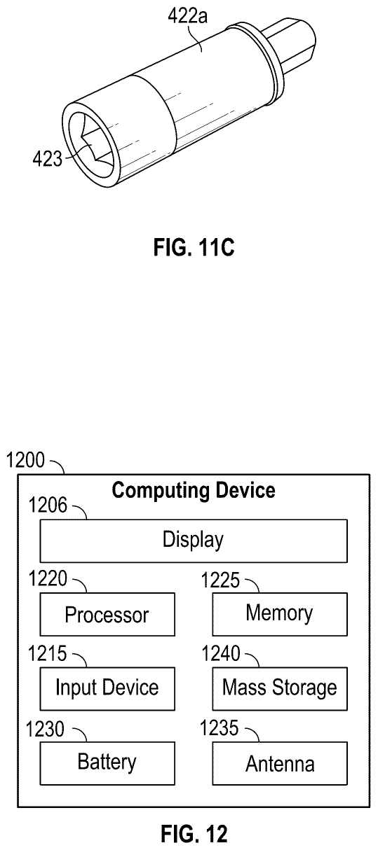

FIG. 2 is a lower front right isometric view of an embodiment of a synchronous fastener drive tool 100. In FIG. 2, drive tool 100 includes a frame 101 having a frame top surface 107 and a bottom plate 103 with a bottom surface 105 and a gear train (e.g., drive tool gear train 204 as discussed with regard to FIG. 6A—and FIG. 9B, or drive tool gear train 404 as discussed with regard to FIG. 10B—FIG. 11B, or drive tool gear train 704 as discussed with regard to FIG. 8C). Bottom plate 103 has a top surface on the side of plate 103 opposite bottom surface 105. Frame 101 may be a housing or chassis as shown that encloses the gear train, or a frame that the gear train is supported by. Fastener drivers 102a . . . 102d extend from the bottom of frame 101 in a configuration that corresponds to the configuration of the target cold plate fasteners, i.e., screws 22a . . . 22d of cold plate 20a (FIG. 1). Fastener drivers 102a . . . 102d may be torx bits to engage with the torx heads of screws 22a . . . 22d. In embodiments, fastener drivers 102a . . . 102d may be a different type of drive to adapt to a different type of fastener, e.g., drivers 102a . . . 102d may be hexes, flat head screwdrivers, Phillips head screwdrivers, or sockets, etc., to drive hex heads, flat head screws, Phillips head screws, and bolts, etc. A center stand-off 104 may rest against cold plate surface 26 after screws 22a . . . 22d are fully seated. Similarly, posts 106a . . . 106d may rest against cold plate 20 after screws 22a . . . 22d are fully seated.

FIG. 3 is an upper front left isometric view of synchronous fastener drive tool 100 in the use case shown in FIG. 1. In FIG. 3, drive tool 100 is shown to include a drive socket 108 extended through frame top surface 107. A hand tool 110 has been placed in drive socket 108. Drive tool 100 is shown in place atop cold plate 20a such that each fastener driver 102a . . . 102d engages the corresponding screw 22a . . . 22d of cold plate 20a. In this embodiment, the rotation of each fastener driver 102a . . . 102d is hard-coupled to the input in drive socket 108, which results in each fastener driver 102a . . . 102d rotating the exact same number of times for each rotation of the input drive socket. In this embodiment, the torques on each fastener, i.e., screws 22a . . . 22d, are not controlled. Thus, the user may rotate hand tool 110 and drive each screw 22a . . . 22d the same amount. In an embodiment, the gear train may be sized such that the ratio of input turns of socket 108 to output turns of fastener drivers 102a . . . 102d is 1:1. In an embodiment, the gear train may be sized such that the ratio of input turns of socket 108 to output turns of fastener drivers 102a . . . 102d is greater than 1:1, which allows the user to exert less torque on socket 108. For example, the ratio may be 4:1, which allows the user to turn socket 108 four times to achieve a single rotation of each fastener driver 102a . . . 102d.

A method of using drive tool 100 to install a cold plate may include the following steps: placing a cold plate with four fasteners in position atop a CPU; positioning drive tool 100 atop the cold plate with each fastener driver 102a . . . 102d engaging a corresponding fastener of the cold plate; and tightening each of the fasteners at the same time the same number of turns by turning drive socket 108 in a first direction. A method of using drive tool 100 to remove a cold plate may include the following steps: positioning drive tool 100 atop the cold plate with each fastener driver 102a . . . 102d engaging a corresponding fastener of the cold plate; undoing each of the fasteners at the same time the same number of turns by turning drive socket 108 in the reverse of the first direction; and removing the cold plate from atop the CPU. The installation method may further include: turning drive socket 108 a predetermined number of turns to cause each fastener to achieve a target preload. Either the installation or removal method may further include: connecting the drive tool to the device using at least one latch. Either the installation or removal method may further include: inserting a tool into drive socket 108; and turning the driving gear using the tool. In an embodiment, the drive tool may include an electric motor connected to the tool and to a controller including a processor and memory including instructions that when executed by the processor cause the electric motor to perform actions including spinning a predetermined number of rotations, and a user may cause the controller to spin the predetermined number of rotations.

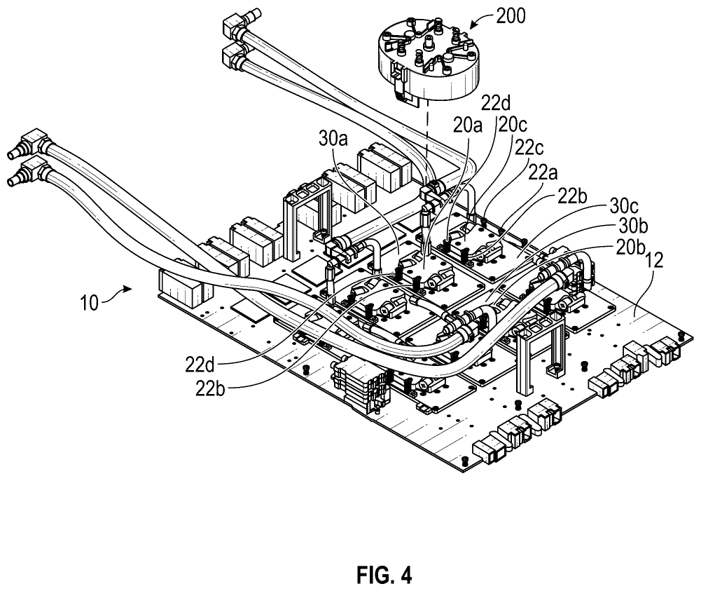

FIG. 4 is an upper front left isometric view of an embodiment of a synchronous fastener drive tool 200 in the use case of FIG. 1. In FIG. 4, drive tool 200 is positioned over cold plate 20a in advance of engaging screws 22a . . . 22d. When drive tool 200 is lowered to engage cold plate 20a, it will be positioned between cold plate 20b atop CPU 30b and cold plate 20c atop CPU 30c.

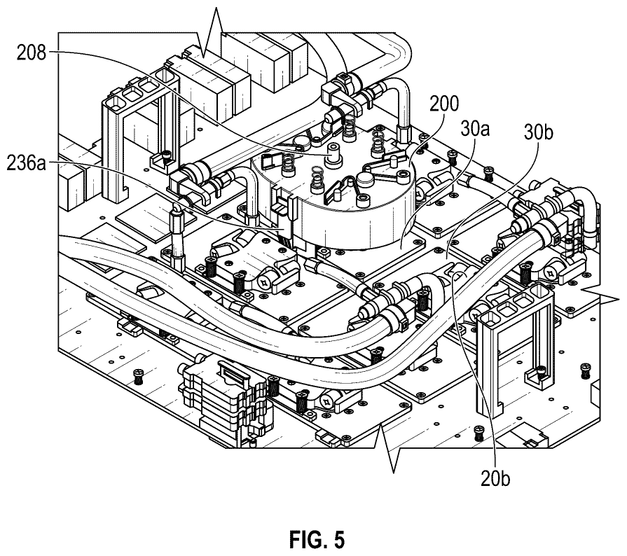

FIG. 5 is an upper front left isometric view of an embodiment of synchronous fastener drive tool 200 in the use case of FIG. 1. In FIG. 5, drive tool 200 has been lowered to engage screws 22a . . . 22d. In the embodiment, drive tool 200 includes a drive tool latch 236a that retains drive tool 200 to cold plate 20a by latching to an edge of cold plate 20a. A drive tool latch 236b (FIG. 6) holds the obscured side of drive tool 200 to cold plate 20a. In this position, a user may insert hand tool 110 into a drive socket 208 and rotate the tool to fasten all four screws 22a . . . 22d simultaneously.

FIG. 6A is an assembly drawing of synchronous fastener drive tool 200. FIG. 6B is a lower isometric view of bottom plate 206. In FIG. 6A, drive tool 200 includes a frame 202 having an upper frame surface 207 and a bottom plate 206 with a bottom surface 203 and a top surface 205. Frame 202 may be a housing or chassis as shown that encloses the gear train, or a frame that the gear train is supported by. Contained within frame 202 and bottom plate 206 is a drive tool gear train 204. Drive tool gear train 204 is symmetrical about the xy and yz planes centered on drive socket 208 (see FIG. 8A). The following disclosure, if describing an exemplary element, should be understood to apply to elements that are symmetrically related to the exemplary element, e.g., a description of a fastener driver 224a and a fastener driver gear 220a is applicable to fastener drivers 224b . . . 224d and their associated fastener driver gears 220b . . . 220d. Drive tool gear train 204 includes a drive socket 208 having a drive gear 210. Drive socket 208 is configured to receive a tool, e.g., hand tool 110, which when rotated causes drive tool gear train 204 to drive each fastener driver 224a . . . 224d an equal number of rotations. That is, each fastener driver 224a . . . 224d rotates an equal number of turns. The number of rotations a fastener driver makes may not be the same as the number of rotations the drive gear 210 rotates. Drive tool gear train 204 transmits the rotation of driving gear 210 equally to each fastener driver gear 220a . . . 220d, each of which is coaxially connected to one of fastener drivers 224a . . . 224d. Drive tool gear train 204 further includes: first idler gears 218a . . . 218d, second idler gears 216a . . . 216d, second drive gears 214a . . . 214d, and third drive gears 212a, 212b. Second drive gears 214a . . . 214d are coaxially connected to third drive gears 212a, 212b. To rotate the four fastener drivers 224a . . . 224d, driving gear 210 transmits rotation to both third drive gears 212a, 212b. Third drive gear 212a is axially connected to second drive gear 214a, which transmits rotation to each second idler gear 216a, 216c. Third drive gear 212b is axially connected to second drive gear 214b, which transmits rotation to each second idler gear 216b, 216d. Thus, the rotation of the driving gear 210 has been multiplied to drive all four second idler gears 216a . . . 216d. Subsequently, each second idler gear 216a . . . 216d transmits rotation to a single first idler gear 218a . . . 218d, respectively. And each first idler gear 218a . . . 218d transmits rotation to a single fastener driver gear 220a . . . 220d, respectively.

In the embodiment, one purpose for second idler gears 216a . . . 216d and first idler gears 218a . . . 218d is to ensure that the number of gears between drive socket 208 and fastener drivers 224a . . . 224d is an odd number. This arrangement of gears results in the rotational direction of fastener driver gears 220a . . . 220d being the same direction as that of drive socket 208. In the embodiment, and as with drive tool 100, fastener drivers 224a . . . 224d may be a different type of driver to adapt to a different type of fastener, e.g., drivers 224a . . . 224d may be hexes, flat head screwdrivers, Phillips head screwdrivers, or sockets, etc.

In the embodiment, the elements of drive tool gear train 204 may be retained in their respective positions using a first partition 232 and a second partition 234 in cooperation with frame 202 bottom plate 206. Fastener drivers 224a . . . 224d are perpendicular to bottom plate 206 and extend toward and, in some embodiments through, driver openings 252a . . . 252d to extend perpendicularly from bottom plate 206. Fastener drivers 224a . . . 224d are received by drive sockets 222a . . . 222d, which are in turn received within and driven by fastener driver gears 220a . . . 220d (e.g., through an opening 248) and pass through openings 242a . . . 242d. First idler gears 218a . . . 218d include axial shafts 304a . . . 304d (FIG. 8B) and may pass through openings such as opening 246 (for idler gear 218a). First idler gears 218a . . . 218d may be biased toward the engaged positions between adjacent second idler gears and fastener driver gears by springs 226a . . . 226d about axial shafts 304a . . . 304d, which work in compression against a lower surface of partition 232. Drive gears 214a, 214b extend through openings 240a, 240b and also through openings in partition 234, e.g., opening 244 for gear 214a. The axial shafts 304a . . . 304d pass through openings 250ad . . . 250d. Drive socket 208 extends through an opening 238 of frame 202. Idler gear latches 230a . . . 230d cooperate with axial shafts 304a . . . 304d to maintain idler gears 218a . . . 218d in a disengaged position as will be discussed within. Slots 256a, 256b guide drive tool latches 236a, 236b when they slide with respect to frame 202. A latch post 266 and a latch post 268 are discussed within with regard to idler gear latch 230b. In FIG. 6B, bottom plate 206 includes guides 254a . . . 254d for receiving screws 22a . . . 22d and positioning tool 200 properly atop cold plate 20a. In an embodiment, each fastener driver gear 220a . . . 220d includes an opening (such as opening 248 of driver gear 220a) into which the respective drive socket 222a . . . 222d is inserted until it protrudes through the top of the driver gear until visible as shown in FIG. 6A.

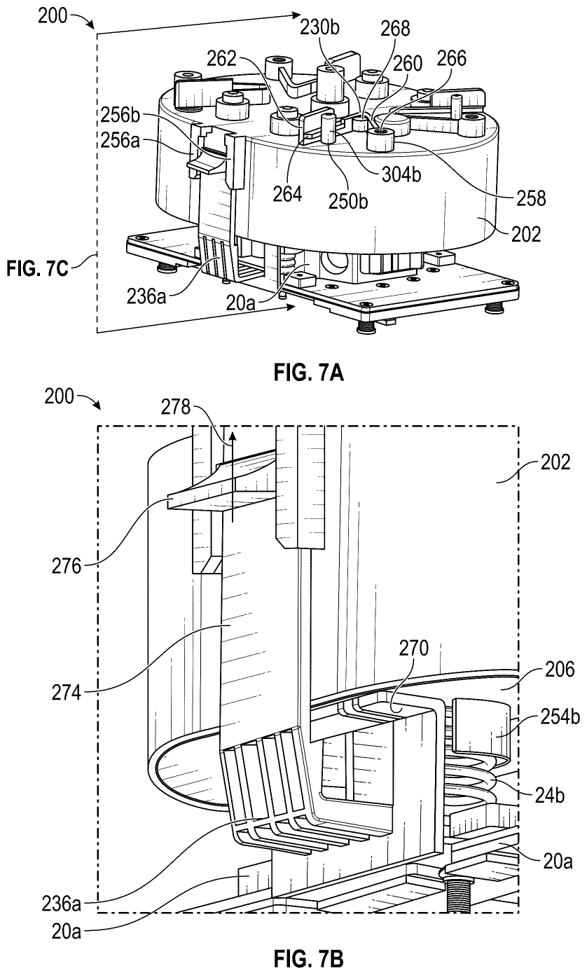

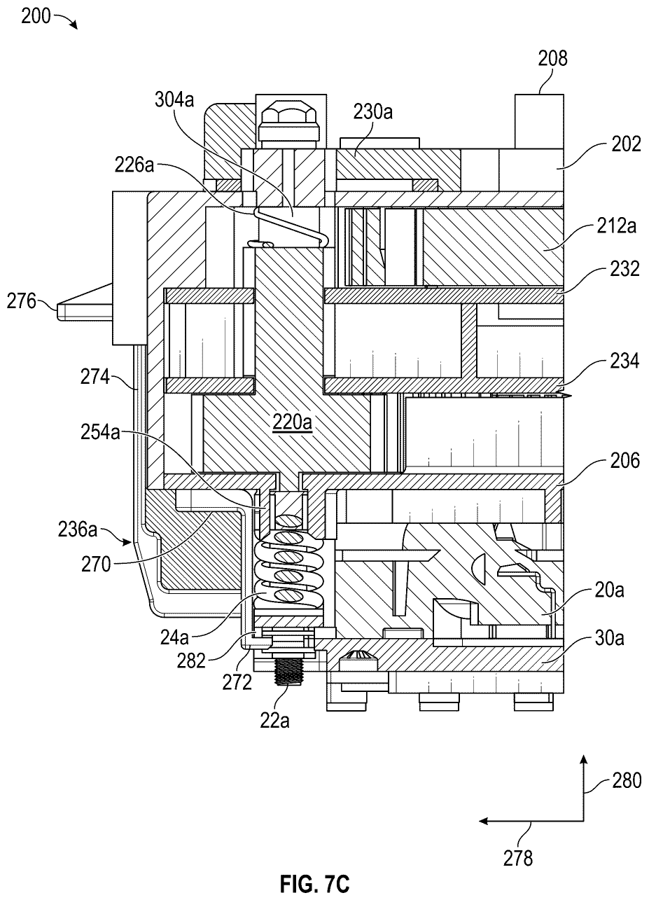

FIG. 7A is an upper front left isometric view of synchronous fastener drive tool 200 in the use case of FIG. 1. FIG. 7B is an isometric view of an enlarged view of a section of drive tool 200. FIG. 7C is a cross-sectional view of the section indicated in FIG. 7A. In FIG. 7A, drive tool 200 is held attached to cold plate 20a by drive tool latches 236a, 236b (FIG. 6A) grasping the edge of cold plate 20a on opposing sides. Drive tool latch 236b is obscured, but the description of drive tool latch 236a applies equally to drive tool latch 236b. FIG. 7A illustrates axial shaft 304b in a lowered, engaged position, which will be discussed further within. Idler gear latch 230b, which is representative of idler gear latches 230a . . . 230d, includes a latch base 258 with an opening that receives latch post 266 (FIG. 6A). Latch spring 260 is bent around latch post 268 and biases a latch tooth 264 against axial shaft 304b. A thumb release 262 may be pushed by a user to move latch tooth 264 away from axial shaft 304b. Drive tool latch 236a further includes a latch foot 700 (FIG. 7B), a latch catch 272 (FIG. 7C), a latch member 274 and a latch handle 276. To release drive tool latch 236a, latch handle 276 is raised in direction 278. Latch foot 270 resists this motion against bottom plate 206. As a result, latch catch 272 is drawn outward 280 (FIG. 7C) and away from an edge 282 (FIG. 7C) of cold plate 20a, which releases drive tool 200 from that side of cold plate 20a. FIG. 7C further illustrates guide 254a receiving the head of screw 22a so that fastener driver 224a (not shown in this figure but centered on the axis of fastener driver gear 220a) is positioned to engage screw 22a.

FIG. 8A is an upper front left isometric view of aspects of fastener drive tool 200. FIG. 8B is an enlarged view of the section indicated in FIG. 8A. In FIG. 8A and FIG. 8B, drive tool gear train 204 is illustrated without elements of frame 202, partition 232, partition 234, or bottom plate 206. Drive tool gear train 204 includes driving gear 210, a first gear train 209a, and a second gear train 209b. Gear train 209a transmits the rotation of driving gear 210 to fastener driver gears 220a, 220c and includes second drive gear 212a, third drive gear 214a, second idler gears 216a, 216c, and first idler gears 218a, 218c. Gear train 209b transmits the rotation of driving gear 210 to fastener driver gears 220b, 220d and includes second drive gear 212b, third drive gear 214b, second idler gears 216b, 216d, and first idler gears 218b, 218d. The following disclosure is directed to the driving of fastener driver 224a, but because of the symmetry of drive tool gear train 204, applies equally to fastener drivers 224b . . . 224d. Drive socket 208 is axially connected to drive gear 210 such that they both may rotate about the z-axis. When drive socket 208 is rotated clockwise (CW) 284 about an axis 286, e.g., using hand tool 110, driving gear 210 causes third drive gear 212a to rotate CCW 290 about an axis 288. Third drive gear 212a is axially connected to second drive gear 214a, which also rotates CCW 290. The rotation of second drive gear 214a causes second idler gear 216a to rotate CW 294 about an axis 292. Second idler gear 216a causes first idler gear 218a to rotate CCW 298 about an axis 296, which causes fastener driver gear 220a to rotate CW 302 about an axis 300. Thus, fastener driver 224a, shown received within drive socket 222a, is driven CW when drive socket 208 is driven CW, or driven CCW when drive socket 208 is driven CCW. Drive socket 222a may include a socket 228 (FIG. 8A), which may protrude through frame 202 and accept a tool, e.g., hand tool 110, to allow the use to turn fastener driver 224a, e.g., when first idler gear 218a is disengaged (FIG. 9B).

FIG. 8B further illustrates that axial shaft 304a includes a notch 306a that is configured to receive latch tooth 264 of idler gear latch 230a, as will be discussed within. Drive socket 222a includes a shoulder 308a, which abuts a lower surface of partition 234 and limits axial motion of fastener driver gear 220a.

FIG. 8C is an upper front isometric view of aspects of an embodiment of a drive tool gear train 704 for a synchronous fastener drive tool. Drive tool gear train 704 may be used to fasten a plurality of fasteners, e.g., screws 22a . . . 22d, as described with regard to drive tool gear trains 204 and 404. Drive tool gear train 704 includes a drive socket 708 having a drive gear 710. Drive socket 708 is configured to receive a tool, e.g., hand tool 110, which when rotated causes drive gear 710 drive each fastener driver gear 720a . . . 720d an equal number of rotations. That is, each fastener driver gear 720a . . . 720d rotates an equal number of turns. The rotation of each fastener driver gear 720a . . . 720d is transmitted to a fastener driver (e.g., such as one of fastener drivers 224a . . . 224d (FIG. 6A)) received coaxially within each drive socket 722a . . . 722d (e.g., as with drive sockets 222a . . . 222d (FIG. 6A). Thus, the rotation of the driving gear 710 has been multiplied to drive all fastener driver gears 220a . . . 220d. However, with drive tool gear train 704, drive gear 710 and fastener driver gears 720a . . . 720d rotate in different directions. That is, when drive socket 708 is rotated clockwise (CW) 284 about an axis 286, e.g., using hand tool 110, driving gear 710 causes each fastener driver gears 710a . . . 720d to rotate CCW 290 about an axis 288.

FIG. 9A is a partially transparent view of synchronous fastener drive tool 200 with first idler gear 218a in an engaged state. FIG. 9B is a partially transparent view of synchronous fastener drive tool 200 with first idler gear 218a in a disengaged state. FIG. 9A and FIG. 9B illustrate the ability to disengage a fastener driver connected to a non-rotating fastener (e.g., a jammed fastener) to allow the other fastener drivers to continue rotating. A user may grasp and raise axial shaft 304a to manually disengage first idler gear 218a from adjacent second idler gear 216a and fastener driver gear 220a. The disengaged first idler gear 218a is illustrated in FIG. 9B. With fastener driver gear 220a disengaged, rotation of drive socket 208 is not transmitted to fastener driver 224a. This provides to the user the ability to disengage a fastener driver that is attempting to drive a jammed fastener, or to disengage all fastener drivers once they are fully tight to keep the gears from jamming and, e.g., make it difficult to remove the drive tool.

In the embodiment, the ability of the user to manually disengage each first idler gear 218a . . . 218d from their adjacent fastener driver gear and second idler gear results in decoupling drive socket 208 from the fastener driver associated with the disengaged first idler gear. The embodiment may further include idler gear latches 230a . . . 230d, which may retain axial shafts 304a . . . 304d, respectively, in the disengaged position. This maintains the disengagement of the idler gear from the fastener driver gear. As illustrated in FIG. 9B with regard to exemplary idler gear latch 230a, a latch tooth 264 of spring 260, which may be called a V-shaped flexure component, is releasably received within notch 306a of axial shaft 304a. This prevents axial shaft 304a from being driven by spring 226a downward and re-engaging with second idler gear 216a and fastener driver gear 220a. The presence of notch 306a may be a visual indicator that the idler gear is fully disengaged. To release idler gear latch 230a, the user may push latch thumb release 262 away from axial shaft 304a, which disengages latch tooth 264 from notch 306a, allowing spring 226a to urge first idler gear 218a down into the engaged position of FIG. 9A.

In an embodiment, a modified version of drive tool gear train 204 may be used within drive tool 100 (FIG. 2) to drive fastener drivers 102a . . . 102d. In such an embodiment, drive tool gear train 204 may be modified by having first idler gears 218a . . . 218d fixed in place-not movable axially—such that the rotations of second idler gears 216a . . . 216d are always transmitted to drive gears 220a . . . 220d and fastener drivers 102a . . . 102d.

A method of using drive tool 200 to install a cold plate may include the following steps: placing a cold plate with four fasteners in position atop a CPU; positioning drive tool 200 atop the cold plate with each fastener driver engaging a corresponding fastener of the cold plate; and tightening each of the fasteners at the same time the same number of turns by turning drive socket 208 in a first direction. A method of using drive tool 200 to remove a cold plate may include the following steps: positioning drive tool 200 atop the cold plate with each fastener driver engaging a corresponding fastener of the cold plate; undoing each of the fasteners at the same time the same number of turns by turning drive socket 208 in the reverse of the first direction; and removing the cold plate from atop the CPU. The installation method may further include: turning drive socket 208 a predetermined number of turns to cause each fastener to achieve a target preload. The installation method may further include: ceasing the turning of drive socket 208; pulling, by the user, at least one axial shaft thereby disengaging the associated first idler gear(s); and turning drive socket 208 to further tighten the fasteners whose associated first idler gears remain engaged. Either the installation or removal method may further include: connecting the drive tool to the device using at least one latch. Either the installation or removal method may further include: inserting a tool into drive socket 208; and turning the driving gear using the tool. In an embodiment, the drive tool may include an electric motor connected to the tool and to a controller including a processor and memory including instructions that when executed by the processor cause the electric motor to perform actions including spinning a predetermined number of rotations, and a user may cause the controller to spin the predetermined number of rotations.

FIG. 10A is an upper front left isometric view of an embodiment of a synchronous fastener drive tool 400. FIG. 10B is an assembly drawing of synchronous fastener drive tool 400. Drive tool 400 may be used in the use case of FIG. 1 to fasten cold plate 20a to CPU 30. FIG. 10A illustrates drive tool 400 including a frame 402, a latch 436a, and an automated driver 600. Latch 436a is substantially similar to drive tool latch 236a of drive tool 200. Drive tool 400 includes a latch 436b on the opposite side of frame 402 and latches 436a, 436b may be used to connect drive tool 400 to cold plate 20a in the manner disclosed with regard to drive tool 200, drive tool latch 236a, and drive tool latch 236b.

The major differences between drive tool 400 and drive tool 200 include the following: the addition of automated driver 600 and torque limiters 422a . . . 422d, and the deletion of idler gears that are moveable between engaged and disengaged positions like those of first idler gears 218a . . . 218d. Automated driver 600 may include a controller 602 with software and an electric drive motor 604 driving a motor drive tool 606. Controller 602 may be programmable by the user to control the rotation (e.g., direction, speed, and number of turns) of electric drive motor 604. In turn, the direction, speed, and number of turns of motor drive tool 606 may be controlled automatically. Thus, automated driver 600 may automate the fastening process by, e.g., limiting the number of turns of motor drive tool 606 to a predetermined value. Torque limiters 422a . . . 422d may be included between fastener driver gears 420a . . . 420d and fastener drivers 424a . . . 424d to limit the torque of each fastener driver to a predetermined value, i.e., the rated torque of the torque limiter. In this manner, the embodiment may ensure that each fastener is torqued to the same value. In an embodiment, programmable controller 602 may include an ATmega328 single-chip microcontroller from Atmel and electric drive motor 604 may be a Gobilda 5202. Torque limiters 422a . . . 422d may include Sloky Fix It Sticks.

In embodiments, each of drive tools 100, 200, and 400 may be provided with features from one or both of the other drive tools. For example, drive tool 200 may be equipped with one or both of automated driver 600 or torque limiters 422a . . . 422d. Similarly, drive tool 400 may be equipped with first idler gears that are movable between engaged and disengaged positions like idler gears 218a . . . 218d of drive tool 200. Similarly, each of drive tools 100, 200, and 400 may not include one or more described features. For example, drive tool 400 may not include one or both of automated driver 600 or torque limiters 422a . . . 422d.

Regarding drive tool 400, in FIG. 10B, drive tool 400 includes frame 402 having an upper frame surface 407 and bottom plate 406 with a bottom surface 403 and a top surface (not shown) on the side of plate 406 opposite bottom surface 403. Contained within frame 402 and bottom plate 406 is a drive tool gear train 404. Frame 402 may be a housing or chassis as shown that encloses the gear train, or a frame that the gear train is supported by. Drive tool gear train 404 is symmetrical about the xy and yz planes centered on drive socket 408 (the same as the illustration in FIG. 8A). The following disclosure, if describing an exemplary element, should be understood to apply to elements that are symmetrically related to the exemplary element, e.g., a description of fastener driver 424a and fastener driver gear 420a is applicable to fastener drivers 424b . . . 424d and their associated fastener driver gears 420b . . . 420d. Drive tool gear train 404 includes a drive socket 408 having a drive gear 410. Drive socket 408 is configured to receive a tool, e.g., motor drive tool 606 of automated driver 600, which when rotated causes drive tool gear train 404 to drive each fastener driver 424a . . . 424d an equal number of rotations. To accomplish this drive tool gear train 404 transmits the rotation of driving gear 410 equally to each fastener driver gear 420a . . . 420d, each of which is coaxially connected to one of fastener drivers 424a . . . 424d. Drive tool gear train 404 further includes: first idler gears 418a . . . 418d, second idler gears 416a . . . 416d, second drive gears 414a . . . 414d, and third drive gears 412a, 412b. Second drive gears 414a . . . 414d are coaxially connected to third drive gears 412a, 412b. To rotate the four fastener drivers 424a . . . 424d, driving gear 410 transmits rotation to both third drive gears 412a, 412b. Third drive gear 412a is axially connected to second drive gear 414a, which transmits rotation to each second idler gear 416a, 416c. Third drive gear 412b is axially connected to second drive gear 414b, which transmits rotation to each second idler gear 416b, 416d. Thus, the rotation of driving gear 410 has been multiplied to drive the four second idler gears 416a . . . 416d. Subsequently, each second idler gear 416a . . . 416d transmits rotation to a single first idler gear 418a . . . 418d, respectively. And each first idler gear 418a . . . 418d transmits rotation to a single fastener driver gear 420a . . . 420d, respectively.

In the embodiment, one purpose for second idler gears 416a . . . 416d and first idler gears 418a . . . 418d is to ensure that the number of gears between drive socket 408 and fastener drivers 424a . . . 424d is an odd number. This arrangement of gears results in the rotational direction of fastener driver gears 420a . . . 420d being the same direction as that of drive socket 408. In the embodiment, and as with drive tools 100, 200, fastener drivers 424a . . . 424d may be a different type of driver to adapt to a different type of fastener, e.g., drivers 424a . . . 424d may be hexes, flat head screwdrivers, Phillips head screwdrivers, or sockets, etc.

In the embodiment, the elements of drive tool gear train 404 may be retained in their respective positions using a first partition 432 and a second partition 434 in cooperation with frame 402 bottom plate 406. Fastener drivers 424a . . . 424d extend toward and, in some embodiments through, driver openings 452a . . . 452d and are perpendicular to bottom plate 406. Fastener drivers 424a . . . 424d are received by sockets (e.g., socket 423, FIG. 11C) of torque limiters 422a . . . 422d, which are in turn received within and driven by fastener driver gears 420a . . . 420d and pass through openings 442a . . . 442d of partition 432 and openings 443a . . . 443d of partition 434. Third drive gears 414a, 414b extend through openings 440a, 440b and also through openings in partition 434, e.g., opening 444 for gear 414a. Drive socket 408 extends into a cylinder 438 configured to receive and retain automated driver 600 in position with motor drive tool 606 engaging drive socket 408. Slots 456a, 456b guide latches 436a, 436b when they slide with respect to frame 402.

FIG. 11A is an upper front left isometric view of aspects of fastener drive tool 400. FIG. 11B is an enlarged view of the section indicated in FIG. 11A. In FIG. 11A and FIG. 11B, drive tool gear train 404 is illustrated without elements of frame 402, partition 432, partition 434, or bottom plate 406. Drive tool gear train 404 includes driving gear 410, a first gear train 409a, and a second gear train 409b. Gear train 409a transmits the rotation of driving gear 410 to fastener driver gears 420a, 420c and includes second drive gear 412a, third drive gear 414a, second idler gears 416a, 416c, and first idler gears 418a, 418c. Gear train 409b transmits the rotation of driving gear 410 to fastener driver gears 420b, 420d and includes second drive gear 412b, third drive gear 414b, second idler gears 416b, 416d, and first idler gears 418b, 418d. The following disclosure is directed to driving fastener driver 424a, but because of the symmetry of drive tool gear train 404, applies equally to fastener drivers 424b . . . 424d. Drive socket 408 is axially connected to drive gear 410 such that they both may rotate about the z-axis. When drive socket 408 is rotated clockwise (CW) 484 about an axis 486, e.g., using motor drive tool 606 of automated driver 600, driving gear 410 causes third drive gear 412a to rotate CCW 490 about an axis 488. Third drive gear 412a is axially connected to second drive gear 414a, which also rotates CCW 490. Second drive gear 414a then causes second idler gear 416a to rotate CW 494 about an axis 492. Second idler gear 416a causes first idler gear 418a to rotate CCW 498 about an axis 496, which causes fastener driver gear 420a to rotate CW 502 about an axis 500. Thus, fastener driver 424a, shown received within torque limiter 422a, is driven CW 502 when drive socket 408 is driven CW 486. Similarly, fastener driver 424a is driven CCW when drive socket 408 is driven CCW.

In embodiments, gear trains 204, 404 are discussed as causing the fastener drivers to rotate the same way as the drive tool. In other embodiment, gear trains may cause the fastener drivers to rotate in the direction opposite that of the drive tool. One of skill will realize that gear trains 204, 404 are exemplary and that in other embodiments different gear trains may be used to accomplish the features of the apparatuses disclosed within this application. In addition, the several embodiments disclose the driving of four fastener drivers with a single drive tool. In other embodiments, gear trains may be provided that drive fewer fastener drivers, e.g., two or three, or more fastener drivers, e.g., five or six, without departing from the teachings of this disclosure.

In an embodiment, for drive tool gear train 204, driving gear 210, second drive gears 214a, 214b, third drive gears 212a, 212b, first idler gears 218a . . . 218d, second idler gears 216a . . . 216d, and fastener driver gears 220a . . . 220d may be sized such that each fastener driver gear rotates between 0.25 and 0.35 revolutions and preferably 0.320 revolutions for each rotation of the driving gear. In an embodiment, first idler gears 218a . . . 218d may disengage from only one of fastener driver gears 220a . . . 220d or second idler gears 216a . . . 216d, respectively, in order to disengage drive tool gear train 204a, 204b from a particular driver gear 220a . . . 220d. For example, in the embodiment, first idler gear 218a may be disengaged from driver gear 220a when in the disengaged position, but still be engaged with second idler gear 216a.

In an embodiment, for drive tool gear train 404, driving gear 410, second drive gears 414a, 414b, third drive gears 412a, 412b, first idler gears 418a . . . 418d, second idler gears 416a . . . 416d, and fastener driver gears 420a . . . 420d may be sized such that each fastener driver gear rotates between 0.25 and 0.35 revolutions and preferably 0.320 revolutions for each rotation of the driving gear.

In an embodiment, a fastener driver may include any of: a socket, a torque limiter including a socket, a torx bit, a flat head bit, a Phillips head bit, or a hex bit.

A method of using drive tool 400 to install a cold plate may include the following steps: placing a cold plate with four fasteners in position atop a CPU; positioning drive tool 400 atop the cold plate with each fastener driver engaging a corresponding fastener of the cold plate; and tightening each of the fasteners at the same time the same number of turns by turning drive socket 408 in a first direction. A method of using drive tool 400 to remove a cold plate may include the following steps: positioning drive tool 400 atop the cold plate with each fastener driver engaging a corresponding fastener of the cold plate; undoing each of the fasteners at the same time the same number of turns by turning drive socket 408 in the reverse of the first direction; and removing the cold plate from atop the CPU. The installation method may further include: turning drive socket 408 a predetermined number of turns to cause each fastener to achieve a target preload. The installation method may further include: tightening each fastener to the same torque by turning drive socket 408 until each torque limiter indicates that the associated fastener has reached the rated torque for the torque limiter. Either the installation or removal method may further include: connecting the drive tool to the device using at least one latch. Either the installation or removal method may further include: inserting a tool into drive socket 208; and turning the driving gear using the tool. In an embodiment, the drive tool may include an electric motor connected to the tool and to a controller including a processor and memory including instructions that when executed by the processor cause the electric motor to perform actions including spinning a predetermined number of rotations determined to cause each fastener to achieve a target preload, and a user may cause the controller to spin the predetermined number of rotations.

FIG. 12 is an exemplary block diagram depicting a computing device of an embodiment, e.g., controller 602. Computing device 1200 may include a display, screen, or monitor 1206, housing 1208, and input device 1215. Housing 1208 houses familiar computer components, some of which are not shown, such as a processor 1220, memory 1225, battery 1230, speaker, transceiver, antenna 1235, microphone, ports, jacks, connectors, camera, input/output (I/O) controller, display adapter, network interface, mass storage devices 1240, various sensors, and the like.

Input device 1215 may also include a touchscreen (e.g., resistive, surface acoustic wave, capacitive sensing, infrared, optical imaging, dispersive signal, or acoustic pulse recognition), keyboard (e.g., electronic keyboard or physical keyboard), buttons, switches, stylus, or combinations of these.

Mass storage devices 1240 may include flash and other nonvolatile solid-state storage or solid-state drive (SSD), such as a flash drive, flash memory, or USB flash drive. Other examples of mass storage include mass disk drives, floppy disks, magnetic disks, optical disks, magneto-optical disks, fixed disks, hard disks, SD cards, CD-ROMs, recordable CDS, DVDS, recordable DVDs (e.g., DVD-R, DVD+R, DVD-RW, DVD+RW, HD-DVD, or Blu-ray Disc), battery-backed-up volatile memory, tape storage, reader, and other similar media, and combinations of these.

Embodiments may also be used with computer systems having different configurations, e.g., with additional or fewer subsystems, and may include systems provided by Arduino, or Raspberry Pi. For example, a computer system could include more than one processor (i.e., a multiprocessor system, which may permit parallel processing of information) or a system may include a cache memory. The computer system shown in FIG. 12 is but an example of a computer system suitable for use with the embodiments. Other configurations of subsystems suitable for use with the embodiments will be readily apparent to one of ordinary skill in the art. For example, in a specific implementation, the computing device is a mobile communications device such as a smartphone or tablet computer. Some specific examples of smartphones include the Droid Incredible and Google Nexus One, provided by HTC Corporation, the iPhone or iPad, both provided by Apple, and many others. The computing device may be a laptop or a netbook. In another specific implementation, the computing device is a non-portable computing device such as a desktop computer or workstation.

A computer-implemented or computer-executable version of the program instructions useful to practice the embodiments may be embodied using, stored on, or associated with computer-readable medium. A computer-readable medium may include any medium that participates in providing instructions to one or more processors for execution, such as memory 1225 or mass storage 1240. Such a medium may take many forms including, but not limited to, nonvolatile, volatile, transmission, non-printed, and printed media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version of the software useful to practice the embodiments may be stored or reside in RAM or cache memory, or on mass storage device 1240. The source code of this software may also be stored or reside on mass storage device 1240 (e.g., flash drive, hard disk, magnetic disk, tape, or CD-ROM). As a further example, code useful for practicing the embodiments may be transmitted via wires, radio waves, or through a network such as the Internet. In another specific embodiment, a computer program product including a variety of software program code to implement features of the embodiment is provided.

Computer software products may be written in any of various suitable programming languages, such as C, C++, C#, Pascal, Fortran, Perl, Matlab (from MathWorks, www.mathworks.com), SAS, SPSS, JavaScript, CoffeeScript, Objective-C, Swift, Objective-J, Ruby, Rust, Python, Erlang, Lisp, Scala, Clojure, and Java. The computer software product may be an independent application with data input and data display modules. Alternatively, the computer software products may be classes that may be instantiated as distributed objects. The computer software products may also be component software such as Java Beans (from Oracle) or Enterprise Java Beans (EJB from Oracle).

An operating system for the system may be the Android operating system, iPhone OS (i.e., iOS), Symbian, BlackBerry OS, Palm web OS, Bada, MeeGo, Maemo, Limo, or Brew OS. Other examples of operating systems include one of the Microsoft Windows family of operating systems (e.g., Windows 95, 98, Me, Windows NT, Windows 2000, Windows XP, Windows XP x64 Edition, Windows Vista, Windows 10 or other Windows versions, Windows CE, Windows Mobile, Windows Phone, Windows 10 Mobile), Linux, HP-UX, UNIX, Sun OS, Solaris, Mac OS X, Alpha OS, AIX, IRIX32, or IRIX64, or any of various operating systems used for Internet of Things (IoT) devices or automotive or other vehicles or Real Time Operating Systems (RTOS), such as the RIOT OS, Windows 10 for IoT, WindRiver VxWorks, Google Brillo, ARM Mbed OS, Embedded Apple iOS and OS X, the Nucleus RTOS, Green Hills Integrity, or Contiki, or any of various Programmable Logic Controller (PLC) or Programmable Automation Controller (PAC) operating systems such as Microware OS-9, VxWorks, QNX Neutrino, FreeRTOS, Micrium μC/OS-II, Micrium μC/OS-III, Windows CE, TI-RTOS, RTEMS. Other operating systems may be used.

Furthermore, the computer may be connected to a network and may interface to other computers using this network. The network may be an intranet, internet, or the Internet, among others. The network may be a wired network (e.g., using copper, and connections such as RS232 connectors), telephone network, packet network, an optical network (e.g., using optical fiber), or a wireless network, or any combination of these. For example, data and other information may be passed between the computer and components (or steps) of a system useful in practicing the embodiments using a wireless network employing a protocol such as Wi-Fi (IEEE standards 802.11, 802.11a, 802.11b, 802.11c, 802.11g, 802.11i, and 802.11n, just to name a few examples), or other protocols, such as BLUETOOTH or NFC or 802.15 or cellular, or communication protocols may include TCP/IP, UDP, HTTP protocols, wireless application protocol (WAP), BLUETOOTH, Zigbee, 802.11, 802.15, 6LoWPAN, LiFi, Google Weave, NFC, GSM, CDMA, other cellular data communication protocols, wireless telephony protocols or the like. For example, signals from a computer may be transferred, at least in part, wirelessly to components or other computers.

In an embodiment, each driving gear (e.g., driving gear 210), each gear train (e.g., gear train 204a), and each fastener driver gear (e.g., fastener driver gear 220a), are sized such that fastener driver gear 220a rotates between 0.25 and 0.35 revolutions and preferably 0.320 revolutions for each rotation of the driving gear. In an embodiment, the driving gear, gear train, and fastener driver gears are sized such that the fastener driver gear rotates between 0.1 and 0.5 revolutions and preferably 0.25 revolutions for each rotation of the driving gear.

Consistent with the foregoing, in at least one case referred to herein as Example A-1, an apparatus comprises: a frame having a bottom plate, the bottom plate having a top surface and a bottom surface; a driving gear connected to the top surface of the bottom plate; a first plurality of fastener drivers oriented perpendicularly to the bottom plate, each of the plurality of fastener drivers coaxially connected to a corresponding one of a first plurality of fastener driver gears connected to the top surface of the bottom plate, the driving gear engaging the first plurality of fastener driver gears such that rotating the driving gear causes each of the first plurality of fastener driver gears to rotate.

In another case referred to herein as Example A-2, the apparatus of Example A-1, or any other exemplary embodiment described herein, may be further limited wherein the driving gear engages the first plurality of fastener driver gears by a first gear train.

In another case referred to herein as Example A-3, the apparatus of Example A-1, or any other exemplary embodiment described herein, may further comprise: a second plurality of fastener drivers oriented perpendicularly to the bottom plate and coaxially connected to a corresponding one of a second plurality of fastener driver gears connected to the top surface of the bottom plate, the driving gear engaging the second plurality of fastener driver gears such that rotating the driving gear causes each of the second plurality of fastener driver gears to rotate.

In another case referred to herein as Example A-4, the apparatus of Example A-3, or any other exemplary embodiment described herein, may be further limited wherein the driving gear engages the first plurality of fastener driver gears by a first gear train and engages the second plurality of fastener driver gears by a second gear train.

In another case referred to herein as Example A-5, the apparatus of Example A-2, or any other exemplary embodiment described herein, may be further limited wherein: the first gear train further comprises, for each fastener driver gear of the plurality of fastener driver gears, a first idler gear moveable perpendicularly to the bottom plate from a first position to a second position, wherein when the first idler gear is in the first position, the driving gear is engaged with the fastener driver gear by the gear train and when the first idler gear is in the second position, the driving gear is disengaged from the fastener driver gear.

In another case referred to herein as Example A-6, the apparatus of Example A-5, or any other exemplary embodiment described herein, may further comprise: a plurality of idler gear latches connected to an upper frame surface of the frame, each idler gear latch having a tooth configured to releasably engage a notch on an axial shaft extending from each first idler gear through the upper frame surface, wherein the tooth engages the notch when the respective first idler gear is in the second position.

In another case referred to herein as Example A-7, the apparatus of Example A-5, or any other exemplary embodiment described herein, may further comprise: a plurality of second idler gears, each second idler gear engaging a corresponding first idler gear of the first gear train when that first idler gear is in the first position; a second drive gear engaging at least two second idler gears of the plurality of second idler gears; and a third drive gear coaxially connected to the second drive gear and engaging the driving gear, the third drive gear being larger than the second drive gear.

In another case referred to herein as Example A-8, the apparatus of Example A-5, or any other exemplary embodiment described herein, may further comprise: a plurality of drive tool latches, each drive tool latch including: i) a handle movable perpendicularly from the frame bottom surface between a latched position and an unlatched position, and ii) a catch connected to the handle and movable perpendicularly from an inward position to an outward position when the handle is moved from the latched position to the unlatched position.

Consistent with the foregoing, in at least one case referred to herein as Example B-1, a system comprises: a frame having a bottom plate, the bottom plate having a top surface and a bottom surface; a driving gear connected to the top surface of the bottom plate; a first plurality of fastener drivers oriented perpendicularly to the bottom plate and coaxially connected to a corresponding one of a first plurality of fastener driver gears connected to the top surface of the bottom plate, the driving gear engaging the first plurality of fastener driver gears such that rotating the driving gear causes each of the first plurality of fastener driver gears to rotate; and an electric motor connected to the driving gear, the electric motor being configured to rotate the driving gear a predetermined number of rotations.

In another case referred to herein as Example B-2, the system of Example B-1, or any other exemplary embodiment described herein, may be further limited wherein the driving gear engages the first plurality of fastener driver gears by a first gear train.

In another case referred to herein as Example B-3, the system of Example B-1, or any other exemplary embodiment described herein, may further comprise: a second plurality of fastener drivers oriented perpendicularly to the bottom plate and coaxially connected to a corresponding one of a second plurality of fastener driver gears connected to the top surface of the bottom plate, the driving gear engaging the second plurality of fastener driver gears such that rotating the driving gear causes each of the second plurality of fastener driver gears to rotate.

In another case referred to herein as Example B-4, the system of Example B-3, or any other exemplary embodiment described herein, may be further limited wherein the driving gear engages the first plurality of fastener driver gears by a first gear train and engages the second plurality of fastener driver gears by a second gear train.

In another case referred to herein as Example B-5, the system of Example B-2, or any other exemplary embodiment described herein, may be further limited wherein the first gear train further comprises, for each fastener driver gear of the plurality of fastener driver gears, a first idler gear moveable perpendicularly to the bottom plate from a first position to a second position, wherein when the first idler gear is in the first position, the driving gear is engaged with the fastener driver gear by the gear train and when the first idler gear is in the second position, the driving gear is disengaged from the fastener driver gear.

In another case referred to herein as Example B-6, the system of Example B-5, or any other exemplary embodiment described herein, may further comprise: a plurality of idler gear latches connected to an upper frame surface of the frame, each idler gear latch having a tooth configured to releasably engage a notch on an axial shaft extending from each first idler gear through the upper frame surface, wherein the tooth engages the notch when the respective first idler gear is in the second position.

In another case referred to herein as Example B-7, the system of Example B-5, or any other exemplary embodiment described herein, may further comprise: a plurality of second idler gears, each second idler gear engaging a corresponding first idler gear of the first gear train when that first idler gear is in the first position; a second drive gear engaging at least two second idler gears of the plurality of second idler gears; and a third drive gear coaxially connected to the second drive gear and engaging the driving gear, the third drive gear being larger than the second drive gear.

In another case referred to herein as Example B-8, the system of Example B-1, or any other exemplary embodiment described herein, may further comprise: a plurality of drive tool latches, each drive tool latch including: i) a handle movable perpendicularly from the frame bottom surface between a latched position and an unlatched position, and ii) a catch connected to the handle and movable perpendicularly from an inward position to an outward position when the handle is moved from the latched position to the unlatched position.

Consistent with the foregoing, in at least one case referred to herein as Example C-1, a method for fastening a device comprises: engaging a plurality of fasteners with a drive tool, the drive tool comprising: i) a frame having a bottom plate, the bottom plate having a top surface and a bottom surface, ii) a driving gear connected to the top surface of the bottom plate, and iii) a first plurality of fastener drivers oriented perpendicularly to the bottom plate, each of the plurality of fastener drivers coaxially connected to a corresponding one of a first plurality of fastener driver gears connected to the top surface of the bottom plate, the driving gear engaging the first plurality of fastener driver gears such that rotating the driving gear causes each of the first plurality of fastener driver gears to rotate; and rotating the driving gear, the rotation causing each fastener driver to rotate a corresponding one of the plurality of fasteners.

In another case referred to herein as Example C-2, the method of Example C-1, or any other exemplary embodiment described herein, may further comprise: connecting the drive tool to the device using at least one drive tool latch.

In another case referred to herein as Example C-3, the method of Example C-1, or any other exemplary embodiment described herein, may further comprise: rotating the driving gear a predetermined number of turns to cause each of the plurality of fasteners to achieve a target preload.

In another case referred to herein as Example C-4, the method of Example C-1, or any other exemplary embodiment described herein, may be further limited wherein rotating the driving gear a predetermined number of turns to cause each of the plurality of fasteners to achieve a target preload is caused by an electric motor connected to the driving gear.

The previous description is provided to enable any person skilled in the art to practice the various aspects described herein. In the embodiments, the separation of various system components in the embodiments described above should not be understood as requiring such separation in all embodiments. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims.

What is claimed is:

1. An apparatus comprising:
a frame having a bottom plate, the bottom plate having a top surface and a bottom surface;
a driving gear connected to the top surface of the bottom plate;
a first plurality of fastener drivers oriented perpendicularly to the bottom plate, each of the plurality of fastener drivers coaxially connected to a corresponding one of a first plurality of fastener driver gears connected to the top surface of the bottom plate, the driving gear engaging the first plurality of fastener driver gears such that rotating the driving gear causes each of the first plurality of fastener driver gears to rotate.

2. The system of claim 1, wherein the driving gear engages the first plurality of fastener driver gears by a first gear train.

3. The system of claim 1, further comprising:
a second plurality of fastener drivers oriented perpendicularly to the bottom plate and coaxially connected to a corresponding one of a second plurality of fastener driver gears connected to the top surface of the bottom plate, the driving gear engaging the second plurality of fastener driver gears such that rotating the driving gear causes each of the second plurality of fastener driver gears to rotate.

4. The apparatus of claim 3, wherein the driving gear engages the first plurality of fastener driver gears by a first gear train and engages the second plurality of fastener driver gears by a second gear train.

5. The apparatus of claim 2, wherein the first gear train further comprises, for each fastener driver gear of the plurality of fastener driver gears, a first idler gear moveable perpendicularly to the bottom plate from a first position to a second position, wherein when the first idler gear is in the first position, the driving gear is engaged with the fastener driver gear by the gear train and when the first idler gear is in the second position, the driving gear is disengaged from the fastener driver gear.

6. The apparatus of claim 5, further comprising a plurality of idler gear latches connected to an upper frame surface of the frame, each idler gear latch having a tooth configured to releasably engage a notch on an axial shaft extending from each first idler gear through the upper frame surface, wherein the tooth engages the notch when the respective first idler gear is in the second position.

7. The apparatus of claim 5, further comprising:
a plurality of second idler gears, each second idler gear engaging a corresponding first idler gear of the first gear train when that first idler gear is in the first position;
a second drive gear engaging at least two second idler gears of the plurality of second idler gears; and
a third drive gear coaxially connected to the second drive gear and engaging the driving gear, the third drive gear being larger than the second drive gear.

8. The apparatus of claim 1, further comprising a plurality of drive tool latches, each drive tool latch including: i) a handle movable perpendicularly from the frame bottom surface between a latched position and an unlatched position, and ii) a catch connected to the handle and movable perpendicularly from an inward position to an outward position when the handle is moved from the latched position to the unlatched position.

9. A system comprising:
a frame having a bottom plate, the bottom plate having a top surface and a bottom surface;
a driving gear connected to the top surface of the bottom plate;
a first plurality of fastener drivers oriented perpendicularly to the bottom plate and coaxially connected to a corresponding one of a first plurality of fastener driver gears connected to the top surface of the bottom plate, the driving gear engaging the first plurality of fastener driver gears such that rotating the driving gear causes each of the first plurality of fastener driver gears to rotate; and
an electric motor connected to the driving gear, the electric motor being configured to rotate the driving gear a predetermined number of rotations.

10. The system of claim 9, wherein the driving gear engages the first plurality of fastener driver gears by a first gear train.

11. The system of claim 9, further comprising:
a second plurality of fastener drivers oriented perpendicularly to the bottom plate and coaxially connected to a corresponding one of a second plurality of fastener driver gears connected to the top surface of the bottom plate, the driving gear engaging the second plurality of fastener driver gears such that rotating the driving gear causes each of the second plurality of fastener driver gears to rotate.

12. The system of claim 11, wherein the driving gear engages the first plurality of fastener driver gears by a first gear train and engages the second plurality of fastener driver gears by a second gear train.

13. The system of claim 10, wherein the first gear train further comprises, for each fastener driver gear of the plurality of fastener driver gears, a first idler gear moveable perpendicularly to the bottom plate from a first position to a second position, wherein when the first idler gear is in the first position, the driving gear is engaged with the fastener driver gear by the gear train and when the first idler gear is in the second position, the driving gear is disengaged from the fastener driver gear.

14. The system of claim 13, further comprising a plurality of idler gear latches connected to an upper frame surface of the frame, each idler gear latch having a tooth configured to releasably engage a notch on an axial shaft extending from each first idler gear through the upper frame surface, wherein the tooth engages the notch when the respective first idler gear is in the second position.

15. The system of claim 13, further comprising:
a plurality of second idler gears, each second idler gear engaging a corresponding first idler gear of the first gear train when that first idler gear is in the first position;
a second drive gear engaging at least two second idler gears of the plurality of second idler gears; and
a third drive gear coaxially connected to the second drive gear and engaging the driving gear, the third drive gear being larger than the second drive gear.

16. The system of claim 9, further comprising a plurality of drive tool latches, each drive tool latch including: i) a handle movable perpendicularly from the frame bottom surface between a latched position and an unlatched position, and ii) a catch connected to the handle and movable perpendicularly from an inward position to an outward position when the handle is moved from the latched position to the unlatched position.

17. A method for fastening a device, comprising:
engaging a plurality of fasteners with a drive tool, the drive tool comprising:
i) a frame having a bottom plate, the bottom plate having a top surface and a bottom surface,
ii) a driving gear connected to the top surface of the bottom plate, and
iii) a first plurality of fastener drivers oriented perpendicularly to the bottom plate, each of the plurality of fastener drivers coaxially connected to a corresponding one of a first plurality of fastener driver gears connected to the top surface of the bottom plate, the driving gear engaging the first plurality of fastener driver gears such that rotating the driving gear causes each of the first plurality of fastener driver gears to rotate; and
rotating the driving gear, the rotation causing each fastener driver to rotate a corresponding one of the plurality of fasteners.

18. The method of claim 17 further comprising connecting the drive tool to the device using at least one drive tool latch.

19. The method of claim 17, further comprising rotating the driving gear a predetermined number of turns to cause each of the plurality of fasteners to achieve a target preload.

20. The method of claim 18, wherein rotating the driving gear a predetermined number of turns to cause each of the plurality of fasteners to achieve a target preload is caused by an electric motor connected to the driving gear.
